(19) United States
(12) Patent Application Publication
(10) Pub. No.: US 2005/0271432 A1
(43) Pub. Date: Dec. 8, 2005

(54) Image heating apparatus and image forming apparatus

(75) Inventor: Takatoshi Chiba, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/143,723

(22) Filed: Jun. 3, 2005

(30) Foreign Application Priority Data
Jun. 8, 2004 (JP) 2004-169572

(51) Int. Cl. G03G 15/20

(52) U.S. Cl. 399/328

(57) ABSTRACT

It is an object of the present invention to delay wear caused by contact between an end of a recording material and a fixing roller and a pressure roller at a constant position, to elongate lifetime of the rollers, and to reduce running cost. In a fixing apparatus T having a fixing roller 1 and a pressure roller 2 which heat an image on a recording material P while nipping and conveying the recording material P, the fixing apparatus T comprises moving means 15 and 17 which move the fixing roller 1 and the pressure roller 2 in a widthwise direction of the recording material P.

### BACKGROUND OF THE INVENTION

1. Field of the Invention

The present invention relates to an image heating apparatus for heating an image, and to an image forming apparatus having the image heating apparatus, such as a copying machine, a printer and a facsimile machine.

2. Description of the Related Art

Generally, an electrophotographic type image forming apparatus such as a copying machine is usually provided with a heating/pressurizing fixing apparatus for fixing a toner image transferred on a recording material such as a recording sheet. A conventional fixing apparatus of this kind includes a fixing roller and a pressure roller which rotate in a state in which they are in contact with each other under pressure, a recording material on which non-fixed toner image is formed is allowed to pass between the fixing roller and the pressure roller to fix the non-fixed toner image.

In such a conventional fixing apparatus, the fixing roller and the pressure roller are secured between frames of the fixing apparatus in a state in which the fixing roller and the pressure roller are prohibited from moving in an axial direction of the rollers and thus, the fixing roller and the pressure roller can not move in the axial direction of the rollers. Therefore, there is a problem that the fixing roller and an end of the recording material which passes between the fixing roller and the pressure roller come into contact with each other, the fixing roller and the pressure roller worn due to this contact, and lifetime thereof is shortened.

As means for solving this problem, Japanese Patent Applications Laid-open No. H2-271377 and No. H5-173445, and Japanese Utility Model Applications Laid-open No. H2-132268 propose that the fixing roller is allowed to move in the axial direction with respect to the pressure roller which is prohibited from moving in the axial direction.

According to the apparatus described in Japanese Patent Applications Laid-open No. H2-271377, the pressure roller is provided at its axial opposite ends with left and right pressure springs having different resilience, and a serviceman interchanges the left and right springs, thereby moving the fixing roller in the axial direction.

In the apparatus described in Japanese Utility Model Applications Laid-open No. H2-132268, the fixing roller is provided at its axial opposite ends with a plurality of grooves, and the fixing roller is retained to the grooves by means of a C-shaped retaining ring such that no backlash is generated in a thrust direction of the roller. A serviceman displaces the retaining position of the C-shaped retaining ring with respect to the grooves, thereby moving the fixing roller in the axial direction.

In the apparatus described in Japanese Patent Application Laid-open No. H5-173445, a separation claw for peeling off a recording material comes into the fixing roller. To reduce the degree of damage of a roller surface by the separation claw, it is proposed to reciprocate the fixing roller in the axial direction.

According to the techniques described in Japanese Patent Applications Laid-open No. H2-271377 and No. H5-173445, and Japanese Utility Model Applications Laid-open No. H2-132268, however, there is a problem that only the fixing roller moves in the axial direction, a mechanism for moving the fixing roller becomes complicated and is increased in size.

This is because that high speed output, high productivity and increase in colors of the image forming apparatus have proceeded in recent years, it is required to apply greater pressure between the fixing roller and the pressure roller, and great force is required to move only the fixing roller under such great pressure.

If only the fixing roller is moved, there is a problem that resilient layers provided on the fixing roller and the pressure roller are locally peeled off, and pressure distribution in the axial direction of the roller is unbalanced.

### SUMMARY OF THE INVENTION

It is an object of the present invention to provide an image heating apparatus comprising: a first rotating member and a second rotating member for heating an image on a recording material by a nip portion; and moving means for moving the first rotating member and the second rotating member in a widthwise direction of the recording material to change a contact position with respect to the recording material.

It is another object of the present invention to provide an image heating apparatus capable of changing a contact position of between the image heating apparatus and a recording material with a simple structure.

It is another object of the invention to provide an image forming apparatus capable of changing a contact position between image heating means and a radius of curvature with a simple structure.

Other objects of the present invention will become apparent in the following description and the accompanying drawings.

### BRIEF DESCRIPTION OF THE DRAWINGS

FIG. 1 is a sectional view showing a structure of a fixing apparatus of a first embodiment of the invention;

FIG. 2 is a plan view showing the structure of the fixing apparatus of the first embodiment of the invention; and

FIG. 3 is a plan view showing a structure of a fixing apparatus of a second embodiment of the invention.

### DETAILED DESCRIPTION OF THE PREFERRED EMBODIMENTS

Preferred embodiments of the present invention will be explained in detail with reference to the drawings.

### First Embodiment

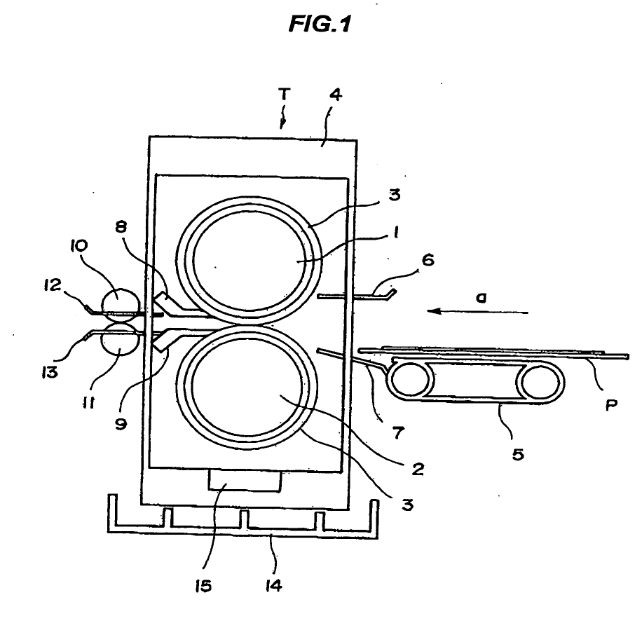

FIG. 1 is a sectional view of a fixing apparatus of a first embodiment. The first embodiment will be explained based on the fixing apparatus used for an electrophotographic type image forming apparatus.

The image forming apparatus comprises an image forming unit as image forming means, and a fixing apparatus (image heating apparatus) as image heating means for fixing non-fixed toner image formed on a recording material. The image forming unit comprises a charger for uniformly charging an electrophotographic photosensitive member as an image bearing member, an exposure apparatus for performing exposures the uniformly charged photosensitive member to light based on image information, a development unit for developing a static image formed on the photosensitive member with toner, and a transfer apparatus for transferring the toner image on the photosensitive member to a recording material. Of course, the image forming apparatus also includes known mechanisms such as a cassette for accommodating the recording material, and a conveyance mechanism for conveying the recording material to the transfer apparatus or fixing apparatus.

The fixing apparatus of the embodiment will be explained below.

As shown in FIG. 1, a recording material P on which a toner image is transferred by the image forming unit is sent in a direction of arrow a, and is introduced into a fixing apparatus T through a conveyance passage 5 and fixing inlet guides 6 and 7.

The fixing apparatus T is provided with a fixing roller 1 as a first rotating member for forming a fixing nip which nips and conveys a recording material P carrying non-fixed toner image, and a pressure roller 2 as a second rotating member. A non-fixed toner image formed on the recording material is pressurized and heated, and is subjected to fixing processing while the toner image passes through the fixing nip.

The fixing apparatus T is provided with a frame member 4 which rotatably supports the fixing roller 1 and the pressure roller 2, a base member 14 which movably supports the frame member 4 in a widthwise direction intersecting the conveyance direction of the recording material P at right angles, and moving means 15 and 17 for moving the frame member 4 which is movably supported by the base member 14 in the widthwise direction of the recording material P.

The recording material P introduced into the fixing apparatus T is heated and pressurized while the recording material P is nipped and conveyed by the fixing roller 1 and the pressure roller 2, and the non-fixed toner image is fixed on the recording material P. In FIG. 1, reference numbers 3 represent rubber layers as resilient layers. The rubber layers 3 are provided on the fixing roller 1 and the pressure roller 2.

In the fixing apparatus T, the recording material P on which the toner image is fixed is separated from the fixing roller 1 or the pressure roller 2 by an upper separation claw 8 which comes into contact with the fixing roller 1 to separate the recording material P from the fixing roller 1, or by a lower separation claw 9 which comes into contact with the pressure roller 2 to separate the recording material P from the pressure roller 2 depending upon a state of the recording material P (large/small of toner amount, water content in recording material P and the like).

The separated recording material P is limited in position by an outlet upper guide 12 and an outlet lower guide 13, and is introduced by an outlet upper roller 10 and an outlet lower roller 11, and conveyed further downstream, and is finally discharged out from the image forming apparatus.

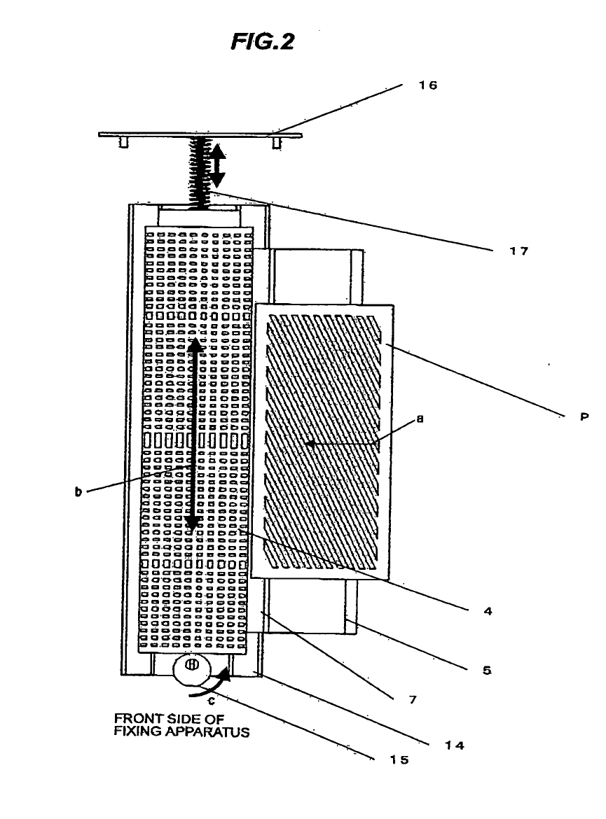

The operation of the fixing apparatus T of this embodiment will be explained. FIG. 2 is a plan view of the fixing apparatus of the embodiment.

The fixing apparatus T can move in the widthwise direction (direction of arrow b) intersecting with the conveyance direction (direction of arrow a) of the recording material P. As shown in FIG. 1, a frame member 4 rotatably supports the fixing roller 1 and the pressure roller 2. The frame member 4 is disposed on a slider base 14 as a base member such that the frame member 4 can move in the widthwise direction of the recording material.

As shown in FIG. 2, a fixing slide cam 15 is disposed on a front side of the fixing apparatus T closer to an operation panel of the image forming apparatus (on one side in the widthwise direction of the recording material). The fixing slide cam 15 is provided on the side of a body of the image forming apparatus.

A slide spring 17 is disposed on a rear plate 16 of the image forming apparatus. The slide spring 17 comes into contact with a deep side (other side in the widthwise direction of the recording material) of the fixing apparatus T, and biases the fixing apparatus T toward the fixing slide cam 15.

The fixing slide cam 15 and the slide spring 17 constitute the moving means which moves the fixing apparatus T (frame member 4) rotatably supported by the slider base 14 in the widthwise direction of the recording material P. That is, the moving means 15 and 17 moves the fixing roller 1 as the first rotating member and the pressure roller 2 as the second rotating member in the widthwise direction of the recording material P (direction of arrow b). At that time, the fixing roller 1 and the pressure roller 2 maintain the pressure-contact state.

The slide spring 17 receives the biasing force. The fixing apparatus T movably disposed on the slider base 14 receives a force which tries to always move toward the front side of the fixing apparatus. The front side of the fixing apparatus T is always pushed against the fixing slide cam 15 by this biasing force.

If the fixing slide cam 15 is rotated in a direction of arrow c in the above-described state, the fixing apparatus T can move in the widthwise direction (direction of arrow b) which intersects with the conveyance direction (direction of arrow a) of the recording material P on the slider base 14.

The contact position with respect to the recording material P is changed by moving the fixing roller 1 and the pressure roller 2 by the moving means 15 and 17 in this manner. With this structure, the end of the recording material P does not always come into contact with a constant positions of the fixing roller 1 and the pressure roller 2, and it is possible to delay the local wearing of the fixing roller 1 and the pressure roller 2 which is caused by contact between the end of the recording material P and the fixing roller 1 and the pressure roller 2.

In this embodiment, it is preferable that the fixing apparatus T is moved in the widthwise direction of the recording material P by the rotation of the fixing slide cam 15 when there is no recording material P between the fixing roller 1 and the pressure roller 2. In the fixing apparatus, subsequent fixing operation is carried out in the moved position.

This is because that if the fixing apparatus T is moved in the widthwise direction intersecting with the conveyance direction of the recording material P at right angles in a state in which the recording material P exists in the fixing apparatus T, when the recording material P is long in the conveyance direction of the recording material, there is a possibility that adverse influence is exerted such as image deviation and discharge failure in a transfer portion of the toner image in the image forming unit upstream from the fixing apparatus or in a conveyance portion for conveying the recording material P at downstream of the fixing apparatus.

As the moving means in the widthwise direction of the recording material P of the fixing apparatus T, the slider cam type moving means which biases the fixing apparatus T in one of the widthwise directions of the recording material by the slide spring 17, and the fixing apparatus T is moved in the widthwise direction of the recording material by the rotation of the slide cam is explained in this embodiment. However, the present invention is not limited to this.

For example, a pinion/rack type may be employed as the moving means. More concretely, a rack gear may be provided in a longitudinal direction (widthwise direction of the recording material) of the frame member 4 which rotatably supports the fixing roller 1 and the pressure roller 2, a pinion gear which meshes with the rack gear and rotates the same may be provided, and the fixing apparatus T may be moved in the widthwise direction of the recording material P by rotating the pinion gear. Even if the pinion/rack type is employed as the moving means for moving the fixing apparatus T in the widthwise direction of the recording material P, the same effect can be obtained.

According to the embodiment, as described above, the fixing roller 1 and the pressure roller 2 are moved in the widthwise direction (direction of arrow b) of the recording material P by the moving means 15 and 17, thereby making it possible to delay the local wearing of the fixing roller and the pressure roller which is caused by contact between the end of the recording material and the fixing roller and the pressure roller at a constant position. With this, the lifetime of each the fixing roller and the pressure roller can be increased and as a result, the frequency of replacement of the fixing roller and the pressure roller is reduced and the running cost can be reduced.

Since the frequency of replacement of the fixing roller and the pressure roller is reduced, time during which the image forming apparatus can not form an image due to the exchange of the fixing roller and the pressure roller can be reduced, and it becomes possible to enhance the productivity of the image forming apparatus.

### Second Embodiment

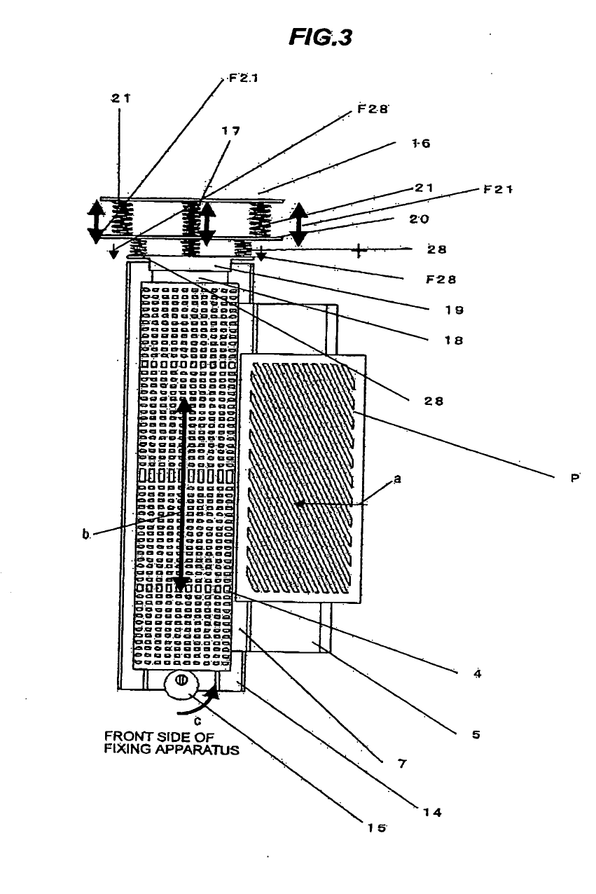

FIG. 3 is a plan view of a fixing apparatus according to a second embodiment. In a fixing apparatus T as an image heating apparatus of the second embodiment, a structure for moving the recording material P in the widthwise direction intersecting with the conveyance direction at right angles is the same as that of the first embodiment.

The fixing apparatus T is provided with an electricity-receiving unit 18 for receiving electricity supply through an electricity-supplying unit 19 from the image forming apparatus body to drive a heater which heats one or both of the fixing roller 1 and the pressure roller 2, and a thermistor (temperature detection means) which detects the temperatures of the fixing roller 1 and the pressure roller 2.

The electricity-receiving unit 18 as the electricity-supplying unit will be explained in detail later. When the recording material is moved in the widthwise direction by the moving means 15 and 17, the electricity-receiving unit 18 can move together with the fixing roller 1 and the pressure roller 2 while maintaining a state in which the electricity-receiving unit 18 is electrically connected to the electricity-supplying unit 19 on the image forming apparatus body side.

In FIG. 3, in a state in which the fixing apparatus T is accommodated in the image forming apparatus body, the electricity-receiving unit 18 on the side of the fixing apparatus T is coupled to the electricity-supplying unit 19 on the side of the image forming apparatus body. In this coupling state, electricity is supplied to the fixing apparatus T from the image forming apparatus body.

When a paper jam occurs in the recording material P of the image forming apparatus due to any reason, the fixing apparatus T is pulled out from the image forming apparatus to clear the paper jam. At that time, the fixing apparatus T is pulled out from the image forming apparatus in every unit in which the fixing slide cam 15 constituting the moving means is provided. When the fixing apparatus T is pulled out from the image forming apparatus, the electricity-receiving unit 18 on the side of the fixing apparatus body is separated from the electricity-supplying unit 19 on the side of the image forming apparatus body, and the electricity supply from the image forming apparatus body to the fixing apparatus T is cut off.

As described above, the fixing apparatus T is pulled out from the image forming apparatus body in some cases, and the electricity-receiving unit 18 and the electricity-supplying unit 19 must be coupled to each other reliably at the set position (position where the fixing can be carried out).

To prevent the connection failure between the electricity-receiving unit 18 and the electricity-supplying unit 19 caused by movement of the fixing apparatus T in the axial direction (direction of arrow b in FIG. 3) by the moving means 15 and 17, the electricity-receiving unit 18 or the electricity-supplying unit 19 is movable maintained so that the electricity-receiving unit 18 and the electricity-supplying unit 19 follow the movement of the fixing apparatus T by the moving means 15 and 17 while maintaining the connecting state between the electricity-receiving unit 18 and the electricity-supplying unit 19.

A structure in which the electricity-supplying unit 19 on the side of the image forming apparatus follows the movement of the electricity-receiving unit 18 of the fixing apparatus T will be explained with reference to FIG. 3. In this embodiment, as shown in FIG. 2, the electricity-supplying unit 19 on the side of the image forming apparatus is disposed on an electricity-supplying unit bracket 20 through an electricity-supplying unit rocking spring 28. The electricity-supplying unit bracket 20 is disposed on the rear plate 16 of the image forming apparatus through an electricity-supplying unit slide spring 21.

If a biasing force of the electricity-supplying unit rocking spring 28 is defined as F28 and a biasing force of the electricity-supplying unit slide spring 21 is defined as F21, the springs 28 and 21 are set such that the following two conditions are satisfied.

A fist condition is F21>F28. A second condition is the first condition is satisfied by a moving stroke in the widthwise direction (direction of arrow b in FIG. 3) of the recording material P of the fixing apparatus T.

By setting the springs 28 and 21 such as to satisfy the two conditions, the electricity-receiving unit 18 and the electricity-supplying unit 19 are separated from each other by the movement of the fixing apparatus T in the widthwise direction of the recording material P by the moving means 15 and 17, and it is possible to prevent the electricity supply from the image forming apparatus body to the fixing apparatus T from being cut off.

As described above, according to the embodiment, even if the fixing apparatus T is moved in the axial direction (direction of arrow b in FIG. 3) by the moving means 15 and 17, the electricity-receiving unit 18 and the electricity-supplying unit 19 follows the movement of the fixing apparatus T while maintaining the connected state between the electricity-receiving unit 18 and the electricity-supplying unit 19. Therefore, it is possible to prevent the electricity-receiving unit 18 and the electricity-supplying unit 19 from separating from each other, and to prevent the electricity supply from the image forming apparatus body to the fixing apparatus T from being cut off.

### Another Embodiment

In the above embodiments, the roller type first rotating member and the second rotating member heat an image on the recording material while nipping and conveying the recording material, but the present invention is not limited to this. For example, the first rotating member and the second rotating member may be belt type rotation bodies using endless belts wound around a plurality of rollers, or may be film rotation bodies which rotate and move around a sleeve, or may be roller type or a combination type of roller and belt types. If the first rotating member and the second rotating member move in the widthwise direction intersecting with the conveyance direction of the recording material at right angles, the same effect can be obtained.

Although the image forming apparatus is not concretely indicated in the above embodiments, the image forming apparatus may be a printer, a copying machine, a facsimile machine and the like, or a multifunction image forming apparatus. If the present invention is applied to an image heating apparatus used for the image forming apparatus, the same effect can be obtained.

Further, the image forming apparatus may be a color image forming apparatus in which various color toner images are sequentially superposed and transferred on a recording material carried on a recording material carrier from a photosensitive member, and the images, or may be a color image forming apparatus in which various color toner images are sequentially superposed and transferred on an intermediate transfer member from a photosensitive member and then, the toner images are transferred on a recording material from the intermediate transfer member by one operation. If the present invention is applied to an image heating apparatus used for the image forming apparatus, the same effect can be obtained.

The present invention is especially effective when a thick recording material is used in a color image forming apparatus.

### CROSS-REFERENCE TO RELATED APPLICATION

This application claims the benefit of priority from the prior Japanese Patent Application No. 2004-169572 filed on Jun. 8, 2004 the entire contents of which are incorporated herein by reference.

1) an image heating apparatus comprising:
a first rotating member and a second rotating member for heating an image on a recording material by a nip portion; and
moving means for moving the first rotating member and the second rotating member in a lateral direction of the recording material to change a contact position with respect to the recording material.

2) The image heating apparatus according to claim 1, wherein the moving means moves the first rotating member and the second rotating member while keeping a pressure contact state of the first rotating member and the second rotating member.

3) The image heating apparatus according to claim 1, wherein the moving means moves the first rotating member and the second rotating member when the recording material does not exist in the nip portion.

4) An image forming apparatus comprising:
image forming means for forming an image on a recording material;
an image heating means for heating the image on the recording material while nipping and conveying the recording material; and
moving means for moving the image heating means to a lateral direction of the recording material to change a contact position with respect to the recording material.

5) The image forming apparatus according to claim 4, wherein the image heating means can be pulled out from the image forming apparatus together with the moving means.

6) The image forming apparatus according to claim 4, further comprising an electricity-supplying unit for supplying electricity to an electricity-receiving unit of the image heating means, and a moving mechanism for moving the electricity-supplying unit with moving of the image heating means by the moving means.
